(19) United States
(12) Patent Application Publication
(10) Pub. No.: US 2024/0280754 A1
(43) Pub. Date: Aug. 22, 2024

(54) OPTO-MECHANICAL ARRAY DEVICE

(71) Applicant: Nippon Telegraph and Telephone Corporation, Tokyo (JP)

(72) Inventors: Motoki Asano, Tokyo (JP); Hiroshi Yamaguchi, Tokyo (JP); Hajime Okamoto, Tokyo (JP)

(21) Appl. No.: 18/569,333

(22) PCT Filed: Jun. 18, 2021
(86) PCT No.: PCT/JP2021/023160

§ 371 Date: Dec. 12, 2023

(51) Int. Cl. G02B 6/293

(52) U.S. Cl. CPC G02B 6/29337

(57) ABSTRACT

An opto-mechanical array element is composed of a rod-shaped matrix having a circular outer shape, and includes, on the matrix, a plurality of coupling portions having a small diameter formed by reducing the diameter at equal intervals, and a bottle-shaped resonance portion between the plurality of coupling portions adjacent to each other. The bottle-shaped resonance portion is configured as a whispering-gallery-mode optical resonator, and mechanical vibration of bottle-shaped resonance portions adjacent to each other can be propagated to each of the plurality of coupling portions.

### CROSS-REFERENCE TO RELATED APPLICATIONS

This application is a national phase entry of PCT Application No. PCT/JP2021/023160, filed on Jun. 18, 2021, which application is hereby incorporated herein by reference.

### TECHNICAL FIELD

The present invention relates to an opto-mechanical array element comprising an optical resonator and a mechanical resonator.

### BACKGROUND

In recent years, signal processing techniques using mechanical resonators have attracted attention. For example, a membrane array structure in which membrane type mechanical resonators are arrayed has been proposed (NPL 1 and NPL 2). In this structure, a plurality of MEMS sensors and actuators can be mounted as an integrated element, and information (signals) carried in the amplitude and phase of mechanical vibration can be propagated and transferred in the array direction by utilizing mechanical vibration coupling between the membrane structures. Thus, realization of a signal transfer network with low power consumption mainly composed of mechanical resonators can be expected.

On the other hand, in order to incorporate such a mechanical resonator network as an IoT element into a node of a conventional optical network, highly efficient opto-mechanical conversion in each mechanical resonator is required. Highly efficient opto-mechanical conversion in a single mechanical resonator is realized by coupling an optical resonator having a strong optical confinement effect with the mechanical resonator (NPL 3). Mechanical opto-mechanical coupling by a micro-bottle resonator has also been proposed (NPL 4).

### CITATION LIST

### Non Patent Literature

NPL 1 D. Hatanaka et al., “Phonon waveguides for electromechanical circuits,” Nature Nanotechnology, vol. 9, pp. 520-524, 2014.
NPL 2 E. Romero et al., “Propagation and Imaging of MechanicalWaves in a Highly Stressed Single-Mode Acoustic Waveguide,” Physical Review Applied, vol. 11, 064035, 2019.
NPL 3 T. J. Kippenberg and K. J. Vahala, “Cavity Opto-Mechanics,” Optics Express, vol. 15, No. 22, pp. 17172-17205, 2007.
NPL 4 M. Asano et al., “Observation of optomechanical coupling in a microbottle resonator,” Laser & Photonics Reviews, vol. 10, Issue 4, 2016.

### SUMMARY

### Technical Problem

However, it is not easy to try to network the above-mentioned opto-mechanical resonator structure in an array, and it has not yet been realized. Actually, it is technically difficult to incorporate optical resonators into each of the conventional membrane structures, and it is difficult to realize the optical resonator array structure based on the conventional mechanical resonator array structure.

Embodiments of the present invention were contrived in order to solve the above problems, and an object thereof is to provide an opto-mechanical array element having a plurality of opto-mechanical resonator structures connected in an array form.

### Solution to Problem

An opto-mechanical array element according to embodiments of the present invention includes, on a rod-shaped matrix having a circular outer shape: a plurality of coupling portions having a small diameter formed by reducing the diameter at equal intervals; and a bottle-shaped resonance portion between the plurality of coupling portions adjacent to each other, the bottle-shaped resonance portion being configured as a whispering-gallery-mode optical resonator.

### Advantageous Effects of Embodiments of the Invention

As described above, according to embodiments of the present invention, since a plurality of bottle-shaped resonance portions configured as whispering-gallery-mode optical resonators are connected by the coupling portions, an opto-mechanical array element in which a plurality of opto-mechanical resonator structures are connected in an array can be provided.

### BRIEF DESCRIPTION OF THE DRAWINGS

FIG. 1 is a configuration diagram showing a configuration of an opto-mechanical array element according to an embodiment of the present invention.

FIG. 2A is a configuration diagram showing a partial configuration of the opto-mechanical array element according to the embodiment of the present invention.

FIG. 2B is a characteristic diagram showing a whispering gallery type optical mode of a bottle-shaped resonator 103.

FIG. 3A is an explanatory diagram for explaining the principle of excitation and measurement of mechanical vibration of the opto-mechanical array element according to the embodiment of the present invention.

FIG. 3B is an explanatory diagram for explaining the principle of excitation and measurement of mechanical vibration of the opto-mechanical array element according to the embodiment of the present invention.

FIG. 4A is a configuration diagram showing a configuration of another opto-mechanical array element according to the embodiment of the present invention.

FIG. 4B is a configuration diagram showing a configuration of another opto-mechanical array element according to the embodiment of the present invention.

FIG. 5A is a configuration diagram showing a configuration of an opto-mechanical array element according to Example 1 of the embodiment of the present invention.

FIG. 5B is a microphotograph of the opto-mechanical array element according to Example 1 of the embodiment of the present invention.

FIG. 5C is a characteristic diagram showing a mechanical vibration signal measured by a first measuring device 108a connected to a first optical fiber 105a.

FIG. 5D is a characteristic diagram showing a mechanical vibration signal measured by a second measuring device 108b connected to the first optical fiber 105a.

FIG. 6A is a configuration diagram showing a configuration of an opto-mechanical array element according to Example 2 of the embodiment of the present invention.

FIG. 6B is a configuration diagram showing a configuration of another opto-mechanical array element according to Example 2 of the embodiment of the present invention.

FIG. 7 is a configuration diagram showing a configuration of an opto-mechanical array element according to Example 3 of the embodiment of the present invention.

FIG. 8 is a configuration diagram showing a configuration of an opto-mechanical array element according to Example 4 of the embodiment of the present invention.

FIG. 9 is a configuration diagram showing a configuration of an opto-mechanical array element according to Example 5 of the embodiment of the present invention.

### DETAILED DESCRIPTION OF ILLUSTRATIVE EMBODIMENTS

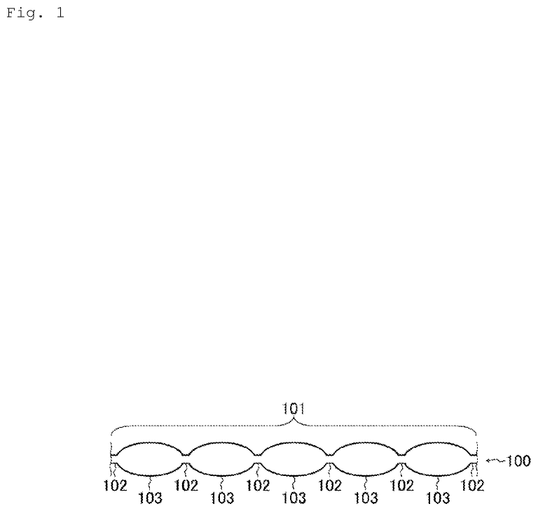

Hereinafter, an opto-mechanical array element according to an embodiment of the present invention will be described with reference to FIG. 1. An opto-mechanical array element 100 is composed of a rod-shaped matrix 101 having a circular outer shape. The matrix 101 can be made of fibers made of glass or plastic.

The matrix 101 is provided with a plurality of coupling portions 102 having a small diameter formed by reducing the diameter at equal intervals, and a bottle-shaped resonance portion 103 between the plurality of coupling portions 102 adjacent to each other. The coupling portion 102 is a part having a smaller diameter than the bottle-shaped resonance portion 103. The bottle-shaped resonance portion 103 has a so-called bottle shape. The coupling portions 102 having a small diameter and a part of the bottle-shaped resonance portion 103 having a large diameter are alternately formed on the columnar matrix 101. The opto-mechanical array element 100 can have a structure in which a plurality of the bottle-shaped resonance portions 103 are coupled by the coupling portions 102. The bottle-shaped resonance portions 103 are whispering-gallery-mode resonators. The bottle-shaped resonance portions 103 are mechanical resonators having a mechanical vibration mode in a radial direction or a deflection angle direction. In each of the plurality of coupling portions 102, mechanical vibration of the bottle-shaped resonance portions 103 adjacent to each other can be propagated.

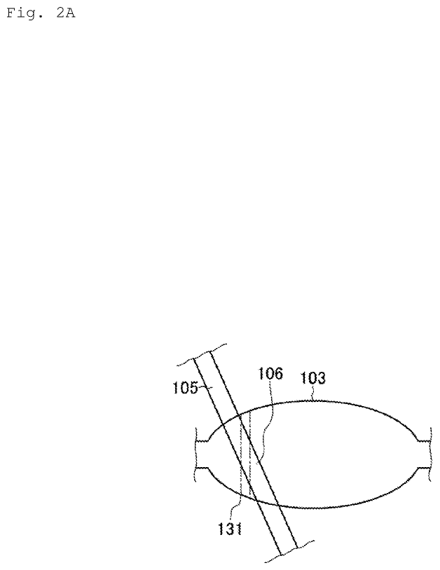

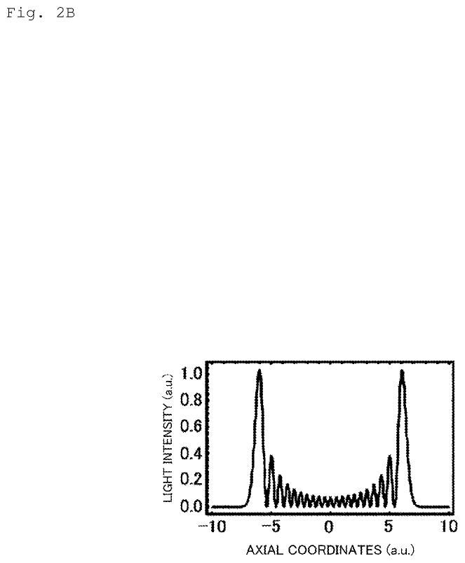

According to the opto-mechanical array element according to an embodiment, for example, as shown in FIG. 2A, an input/output portion 106 of an optical fiber 105 is arranged close to a region having a large state density of the bottle-shaped resonance portion 103, so that photons are injected into a whispering gallery mode 131 of the bottle-shaped resonance portion 103 to excite optical resonance. The bottle-shaped resonance portion 103 has a whispering gallery-type optical mode with an axial light intensity (state density) distribution, as shown in FIG. 2B.

Further, the optical resonance of the whispering gallery mode of the bottle-shaped resonance portion 103 can be read out by the optical fiber 105. The input/output portion 106 is a region that, for example, removes the coating of the optical fiber 105, and further reduces the thickness of the clad layer to enable light leakage from the core. The input/output portion 106 is arranged close to a distance at which the core of the optical fiber 105 and the whispering gallery mode of the bottle-shaped resonance portion 103 can be optically coupled, thereby enabling the excitation and reading described above. Further, by using an optical element such as a prism, the above-mentioned excitation and reading can be performed.

The above-mentioned optical resonance is periodically modulated under the influence of mechanical resonance which vibrates at the natural frequency of the bottle-shaped resonance portion 103. In other words, in the opto-mechanical array element 100, light and mechanical vibration interact with each other. Therefore, by using the opto-mechanical array element 100, the magnitude of mechanical vibration can be read with high sensitivity through modulation of optical resonance. By utilizing this principle, excitation, control and measurement of minute mechanical vibration (displacement) can be realized.

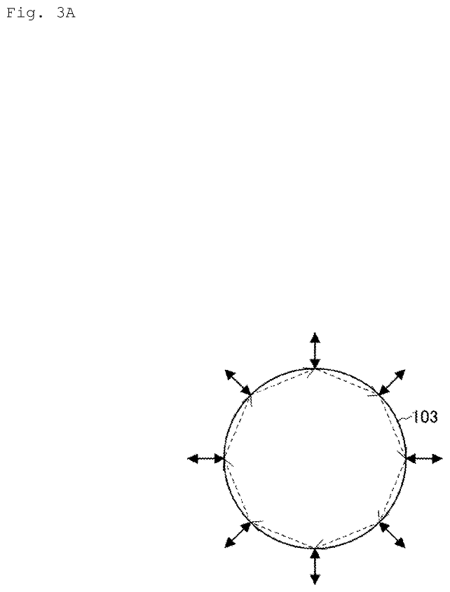

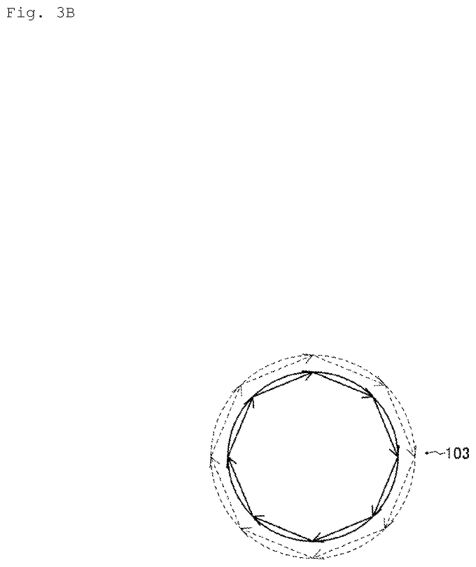

The specific principle of excitation and measurement of mechanical vibration is explained with reference to FIG. 3A, using a radial vibration mode of the bottle-shaped resonance portion 103 as an example. In FIG. 3A, the dotted line indicates the propagation of light and the solid line indicates the direction of mechanical vibration. The mechanical vibration of the bottle-shaped resonance portion 103 is excited by a radiation pressure generated by photons in the whispering gallery mode which circulates around the radius diameter of the bottle-shaped resonance portion 103 many times. Since the whispering gallery optical mode is a mode in which the bottle-shaped resonance portion 103 circulates while being totally reflected in the deflection angle direction, it is possible to generate radiation pressure in the radial direction at each point of total reflection.

On the other hand, the measurement of the mechanical vibration of the bottle-shaped resonance portion 103 can be performed through a change of the phase or frequency of the light generated by a change of the effective propagation length of the optical mode due to the displacement in the radial direction (FIG. 3B). In FIG. 3B, the solid line shows a state where there is no displacement, and the dotted line shows a state where there is displacement.

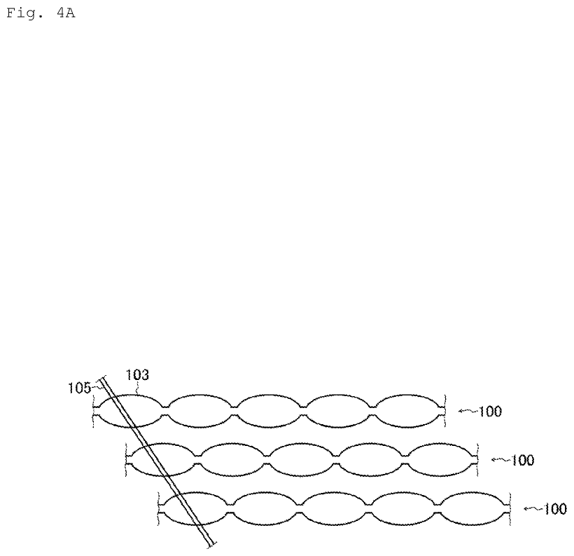

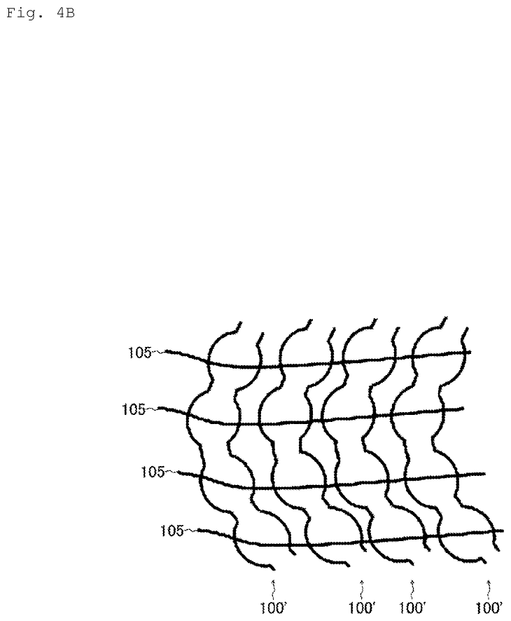

Further, as shown in FIG. 4A, by bridging the thinned optical fiber 105 as an optical waveguide between the plurality of opto-mechanical array elements 100, communication of signals between the elements can be implemented by light. In addition, since the matrix 101 is composed of a material that allows the coupling portions 102 to bend, by using a bendable material as a cylindrical matrix as shown in FIG. 4B, the opto-mechanical array element 100 having flexibility in shape can be formed.

In the opto-mechanical array element 100 according to the embodiment, by appropriately adjusting and designing the interval between the bottle-shaped resonance portions 103 (the length of the coupling portion 102 in the coupling direction), which is a structural unit, the mechanical vibration modes can be overlapped (coupled), and thereby the mechanical vibration can be propagated and transferred in the array direction (coupling direction).

The opto-mechanical array element 100 according to the embodiment can directly process information as mechanical vibration of a vibration sensor, an actuator, and a filter node on a one-dimensional array. Furthermore, signal amplification and attenuation of vibration propagation by light can be realized by utilizing parametric opto-mechanical interaction with respect to mechanical vibration propagating among the plurality of bottle-shaped resonance portions 103.

The matrix 101 can be made of a material that allows the coupling portion 102 to twist around the axis. With this configuration, by applying tension and torsional stress from both ends of the opto-mechanical array element 100, optical characteristics and mechanical characteristics in the bottle-shaped resonance portions 103 incorporated in the opto-mechanical array element 100 can be controlled at the same time.

The matrix 101 can also be formed into a cylindrical shape. With this configuration, a silica optical fiber or the like having a core region capable of propagating light in the cylindrical axis direction can be arranged in the center of the cylindrical matrix 101, and tension and torsional stress applied to the opto-mechanical array element 100 can be read by using the light propagating through the optical fiber (core).

By using the opto-mechanical array element 100 according to the embodiment, it is possible to sense disturbance by light by utilizing the fact that mechanical resonance in the bottle-shaped resonance portion 103 of each unit structure is modulated by disturbance. Further, by using the opto-mechanical array element 100, the inside of the hollow structure of the matrix 101 is used as a flow passage, thereby enabling fluid control by vibration of the plurality of bottle-shaped resonance portions 103.

Hereinafter, more details will be described using examples.

### Example 1

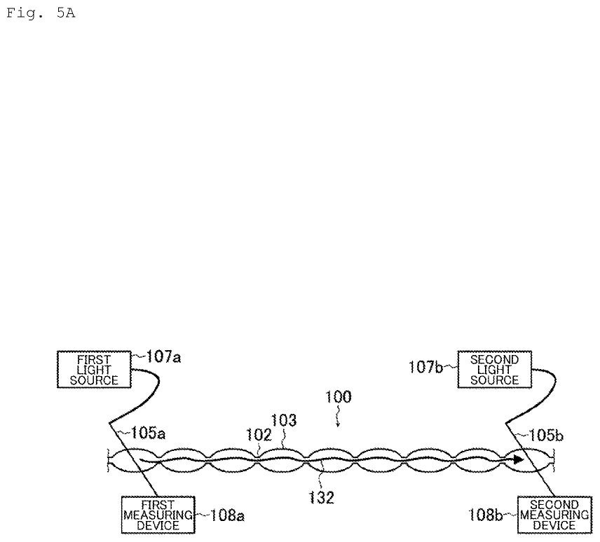

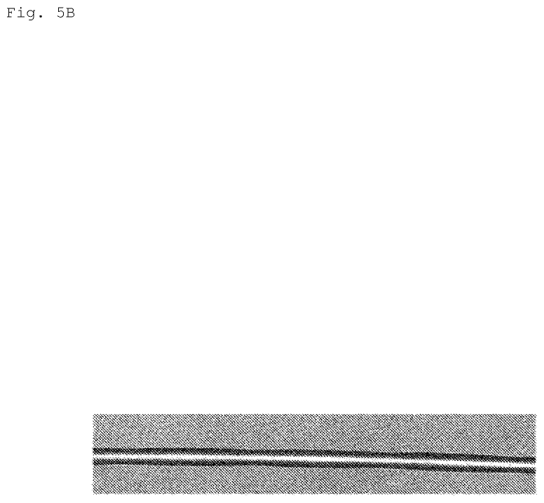

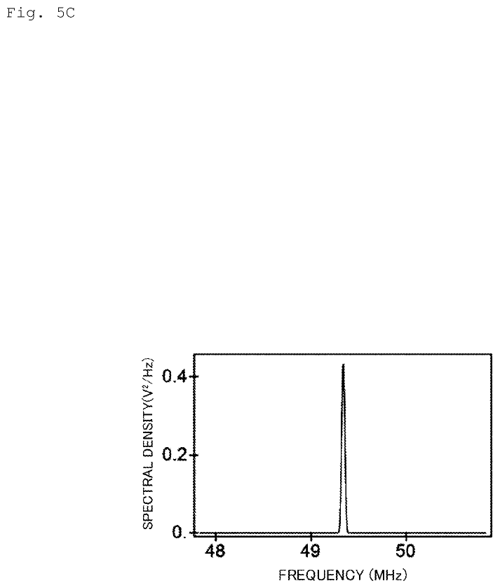

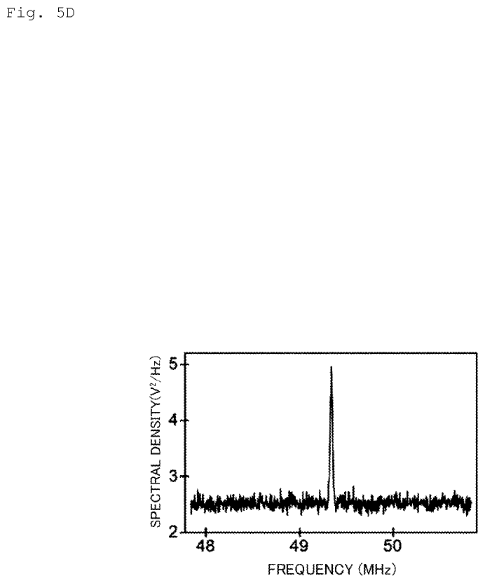

First, Example 1 will be described with reference to FIG. 5A. In Example 1, using a silica optical fiber as a matrix and forming the coupling portions 102 at equal intervals by using a fiber processing machine, the plurality of bottle-shaped resonance portions 103 were formed, and the opto-mechanical array element 100 was manufactured. The coupling portions 102 were formed by forming a neck having a diameter of 70 μm in a silica optical fiber clad with a diameter of 80 μm. In addition, by forming the coupling portions 102 at 550 μm intervals, nine bottle-shaped resonance portions 103 were formed to obtain the opto-mechanical array element 100. FIG. 5B shows a microphotograph of a part of the actually prepared opto-mechanical array element 100.

The input/output portion of a first optical fiber 105a is optically coupled to the bottle-shaped resonance portion 103 on one end side of the opto-mechanical array element 100, and the input/output portion of a second optical fiber 105b is optically coupled to the bottle-shaped resonance portion 103 on the other end side. The input/output portion of each optical fiber is a part where the clad diameter is thinned to approximately the optical wavelength (˜1.5 μm). Each optical fiber is fixed in a state where the input/output portion is made close to the corresponding bottle-shaped resonance portion 103 up to approximately the optical wavelength.

A first light source 107a is connected to one end of the first optical fiber 105a, and a first measuring device 108a is connected to the other end. A second light source 107b is connected to one end of the second optical fiber 105b, and a second measuring device 108b is connected to the other end. For example, each light source can be configured as, for example, a laser device. Each measuring device can be constituted by a light receiving element such as a photodiode.

By introducing light into the first optical fiber 105a, mechanical vibration 132 by light is excited to the opto-mechanical array element 100. On the other hand, the change of the light introduced into the second optical fiber 105b is measured by the second measuring device 108b, to measure the mechanical vibration 132 generated in the opto-mechanical array element 100.

By appropriately adjusting the frequency of the laser beam emitted from the first light source 107a, a mechanical vibration signal having a peak near 49.2 MHz as shown in FIG. 5C is measured by the first measuring device 108a connected to the first optical fiber 105a. On the other hand, by adjusting the frequency of the laser beam emitted from the second light source 107b at the same time, a signal having a peak near 49.2 MHz as shown in FIG. 5D is measured by the second measuring device 108b.

The laser power of the second light source 107b is set at 10 μW which is three digits smaller than that of the first light source 107a, and excessive vibration excitation due to a detection laser is suppressed to a negligible level. This experimental result shows that vibration is propagated between the bottle-shaped resonance portion 103 on one end side of the opto-mechanical array element 100 and the bottle-shaped resonance portion 103 on the other end side, and shows that a one-dimensional opto-mechanical array element is realized.

### Example 2

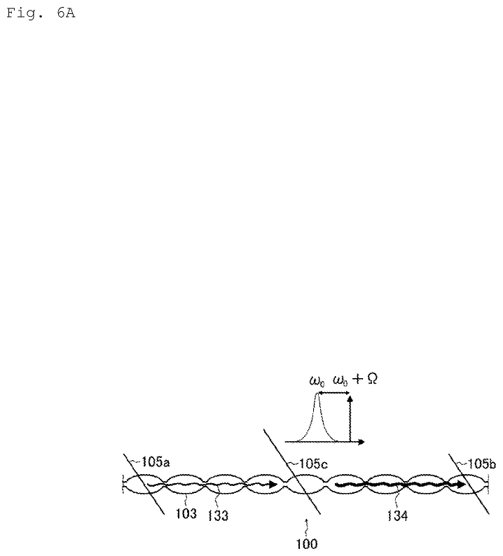

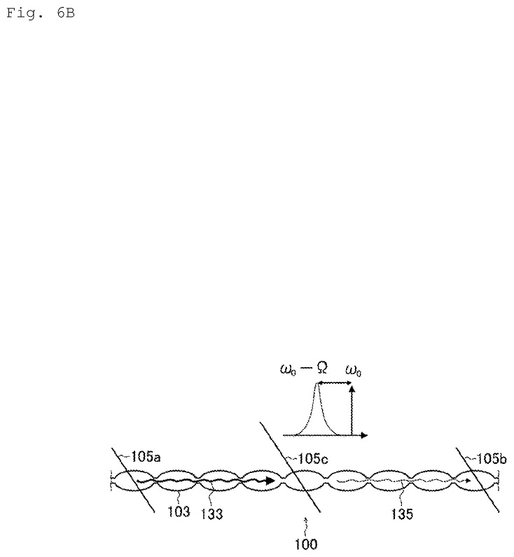

Next, Example 2 will be described with reference to FIGS. 6A and 6B. In Example 2 as well, the same opto-mechanical array element 100 as in Example 1 was manufactured and used. In Example 2 as well, the first optical fiber 105a and the second optical fiber 105b are provided in the same manner as in Example 1. Although not shown, a first light source and a first measuring device are connected to the first optical fiber 105a. Also, although not shown, a second light source and a second measuring device are connected to the second optical fiber 105b.

In addition, Example 2, an input/output portion of a third optical fiber 105c is optically coupled to the bottle-shaped resonance portion 103 provided at the center of the opto-mechanical array element 100. A third light source (not shown) is connected to one end of the third optical fiber 105c, and a third measuring device (not shown) is connected to the other end.

A vibration 133 that is excited by the light of the first light source for excitation to the bottle-shaped resonance portion 103 on one end side reaches the bottle-shaped resonance portion 103 provided in the center. In this case, by setting the frequency of the light input from the third light source to the third optical fiber 105c to the sum frequency of the optical resonance frequency and the mechanical vibration frequency, a vibration 134 obtained by parametric amplification of the vibration 133 can be obtained, as shown in FIG. 6A. Further, by setting the frequency of the light input from the third light source to the third optical fiber 105c to the difference frequency between the optical resonance frequency and the mechanical vibration frequency, a vibration 135 obtained by parametric attenuation of the vibration 133 can be obtained, as shown in FIG. 6B.

### Example 3

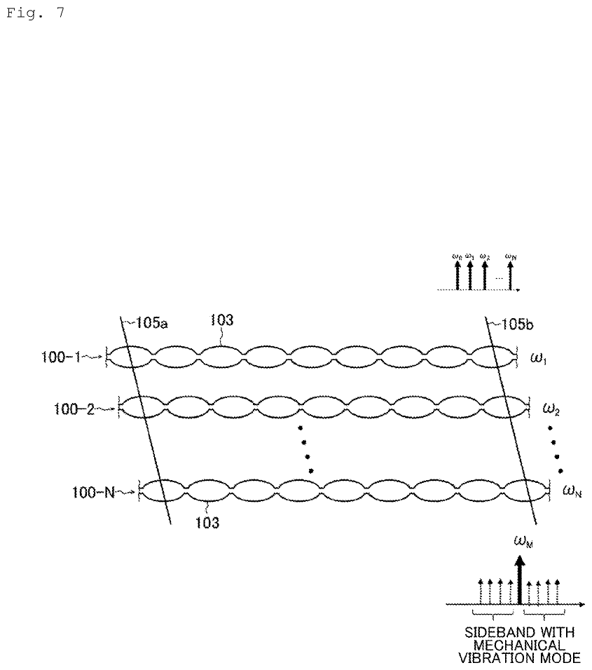

Next, Example 3 will be described with reference to FIG. 7. In Example 8, a plurality (N) of opto-mechanical array elements 100-1, 100-2, . . . , 100-N (N is a natural number) are used. Each of the opto-mechanical array elements is the same as that of Example 1. The first optical fiber 105a is coupled to the bottle-shaped resonance portion 103 on one end side of the opto-mechanical array element 100-1, the opto-mechanical array element 100-2, . . . , the opto-mechanical array element 100-N, and the second optical fiber 105b is coupled to the bottle-shaped resonance portion 103 on the other end side.

Although not shown, a first light source and a first measuring device are connected to the first optical fiber 105a. Also, although not shown, a second light source and a second measuring device are connected to the second optical fiber 105b. The first optical fiber 105a is used to excite the coupled mechanical vibration mode to each of the opto-mechanical array elements. Further, optical reading is performed by using the second optical fiber 105b.

The light obtained from the second light source is frequency-multiplexed by an acousto-optic modulator (AOM) or the like to the second optical fiber 105b, and input to the second optical fiber 105b. Thus, the information of mechanical vibration to each of the opto-mechanical array elements 100-1, 100-2, . . . , 100-N can be measured independently by the optical frequency.

For example, the coupled mechanical vibration mode of the M-th opto-mechanical array element appears in a beat signal of an optical detection signal as a sideband appearing around the frequency. When a disturbance occurs in the system, the coupled mechanical vibration mode is modulated in accordance with the position of the unit structure subjected to the disturbance. By reading this modulation from a spectral change of the sideband described above, it is possible to specify the opto-mechanical array element and the position affected by disturbance.

### Example 4

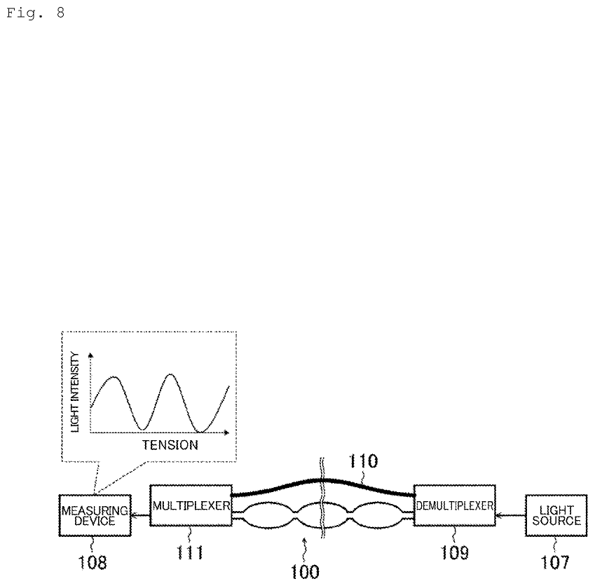

Next, Example 4 will be described with reference to FIG. 8. In Example 4 as well, the same opto-mechanical array element 100 as in Example 1 was manufactured and used. In Example 4, a multiplexer 11 is optically coupled to one end of the opto-mechanical array element 100, and a demultiplexer 109 is optically coupled to the other end. An optical fiber 110 for reference light is connected to the demultiplexer 109 and the multiplexer 11. The splitter 111 can be constituted by, for example, a 50:50 beam splitter.

In Example 4, the light emitted from the light source 107 is demultiplexed into the opto-mechanical array element 100 and the optical fiber 110 for reference light by the demultiplexer 109. Further, the light branched and guided (propagated) through the opto-mechanical array element 100 and the optical fiber 110 for reference light is multiplexed by the multiplexer nil and measured by the measuring device 108. In Example 4, an interferometer is constructed by the opto-mechanical array element 100 and the optical fiber 110 for reference light.

In this interferometer, when tension is applied to the opto-mechanical array element 100 in the coupling direction, input light modulation is performed in the opto-mechanical array element 100 by a change in refractive index due to the tension application. By causing the modulated light to interfere with the reference light propagating through the optical fiber 11o for reference light in the multiplexer 1l, the change in the tension described above can be measured by the measuring device 108.

### Example 5

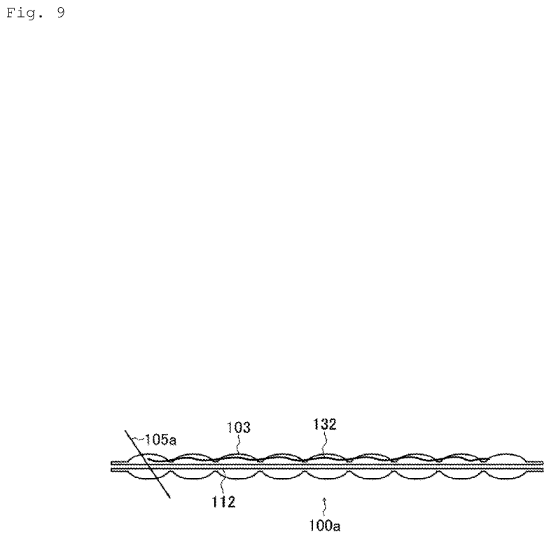

Next, Example 5 will be described with reference to FIG. 9. In Example 5, an opto-mechanical array element 100a having a hollow structure is manufactured by using a cylindrical matrix. As the cylindrical matrix, for example, a hollow silica capillary can be used. The opto-mechanical array element 100a is provided with a flow passage 112 therein. The first optical fiber 105a is coupled to, for example, the bottle-shaped resonance portion 103 on one end side of the opto-mechanical array element 100a. A light source for excitation is connected to the first optical fiber 105a.

In Example 5, water, for example, is introduced into the flow passage 112. In this state, the mechanical vibration 132 in the coupled mechanical vibration mode is excited to the bottle-shaped resonance portion 103 by using the first optical fiber 105a. As a result, a flow is generated in the water introduced into the flow passage 112. As described above, according to Example 5, the fluid can be transported through the flow passage 112.

As described above, according to embodiments of the present invention, since a plurality of bottle-shaped resonance portions configured as whispering-gallery-mode optical resonators are connected by the coupling portions, an opto-mechanical array element in which a plurality of opto-mechanical resonator structures are connected in an array form can be provided.

Note that it is clear that the present invention is not limited to the embodiments described above, and within the technical concept of the present invention, many modifications and combinations can be implemented by those skilled in the art.

### REFERENCE SIGNS LIST

100 . . . Opto-mechanical array element, 101 . . . Matrix, 102 . . . Coupling portion, 103 . . . Bottle-shaped resonance portion.

1-6. (canceled)

7. An opto-mechanical array element, comprising:
a rod-shaped matrix having a circular outer shape in a top down view, the rod-shaped matrix comprising:
a plurality of coupling portions arranged at equal intervals; and
a plurality of bottle-shaped resonance portions, each of the plurality of bottle-shaped resonance portions being disposed between and connecting adjacent ones of the plurality of coupling portions, the plurality of bottle-shaped resonance portions being configured as a whispering-gallery-mode optical resonator, wherein the plurality of coupling portions each have a smaller diameter than the plurality of bottle-shaped resonance portions.

8. The opto-mechanical array element according to claim 7, wherein
each of the plurality of coupling portions is configured to enable propagation of mechanical vibration of the plurality of bottle-shaped resonance portions adjacent to each other.

9. The opto-mechanical array element according to claim 8, wherein the rod-shaped matrix is made of a material allowing the coupling portions to bend.

10. The opto-mechanical array element according to claim 9, wherein the rod-shaped matrix is made of a material allowing the coupling portions to twist around an axis.

11. The opto-mechanical array element according to claim 10, wherein the rod-shaped matrix is made of fibers made of glass or plastic.

12. The opto-mechanical array element according to claim 9, wherein the rod-shaped matrix is made of fibers made of glass or plastic.

13. The opto-mechanical array element according to claim 8, wherein the rod-shaped matrix is made of fibers made of glass or plastic.

14. The opto-mechanical array element according to claim 8, wherein the rod-shaped matrix is made of a material allowing the coupling portions to twist around an axis.

15. The opto-mechanical array element according to claim 7, wherein the rod-shaped matrix is made of a material allowing the coupling portions to twist around an axis.

16. The opto-mechanical array element according to claim 7, wherein the rod-shaped matrix is made of a material allowing the coupling portions to bend.

17. The opto-mechanical array element according to claim 7, wherein the rod-shaped matrix is made of fibers made of glass or plastic.

18. The opto-mechanical array element according to claim 8, wherein the rod-shaped matrix is cylindrical.

19. A opto-mechanical array element comprising:
a ring structure comprising:
a plurality of coupling portions arranged at equal intervals; and
a plurality of resonance portions, each of the plurality of resonance portions being disposed between and connecting adjacent ones of the plurality of coupling portions, the plurality of resonance portions being configured as a whispering-gallery-mode optical resonator, wherein each of the plurality of resonance portions has a diameter that decreases to a diameter of an adjacent one of the plurality of coupling portions.

20. The opto-mechanical array element according to claim 19, wherein
each of the plurality of coupling portions is configured to enable propagation of mechanical vibration of the plurality of resonance portions adjacent to each other.

21. The opto-mechanical array element according to claim 19, wherein the ring structure is made of a material allowing the coupling portions to bend.

22. The opto-mechanical array element according to claim 19, wherein the ring structure is made of a material allowing the coupling portions to twist around an axis.

23. The opto-mechanical array element according to claim 19, wherein the ring structure is made of fibers made of glass or plastic.
